(19) United States
(12) Patent Application Publication
(10) Pub. No.: US 2024/0199007 A1
(43) Pub. Date: Jun. 20, 2024

(54) Device and Method for Controlling Vehicle

(71) Applicants: Hyundai Motor Company, Seoul (KR); Kia Corporation, Seoul (KR)

(72) Inventor: Il Hwan Kim, Hwaseong-Si (KR)

(21) Appl. No.: 18/214,095

(22) Filed: Jun. 26, 2023

(30) Foreign Application Priority Data
Dec. 14, 2022 (KR) 10-2022-0175191

(51) Int. Cl. B60W 30/095; B60W 30/12; B60W 40/04; G08G 1/16

(52) U.S. Cl. CPC B60W 30/095; B60W 30/12; B60W 40/04; G08G 1/167; B60W 2554/402; B60W 2554/4044; B60W 2554/4045; B60W 2556/40

(57) ABSTRACT

A device for controlling a host vehicle includes a sensor for obtaining sound associated with a target vehicle, and a controller configured to determine, based on the sound associated with the target vehicle, an estimated path of the target vehicle, determine, based on a map of an area associated with the host vehicle, road information associated with the estimated path of the target vehicle, determine, based on the road information, whether the target vehicle is anticipated to merge onto a route of the host vehicle, and, based on a determination that the target vehicle is anticipated to merge onto the route of the host vehicle, cause the host vehicle to take an evasive action.

### CROSS-REFERENCE TO RELATED APPLICATION

This application claims the benefit of priority to Korean Patent Application No. 10-2022-0175191, filed in the Korean Intellectual Property Office on Dec. 14, 2022, the entire contents of which are incorporated herein by reference.

### TECHNICAL FIELD

The present disclosure relates to a device and a method for controlling a vehicle.

### BACKGROUND

An automated lane keeping system (ALKS) may be applied to a vehicle that has a driver and is able to travel at a maximum speed of a predetermined speed (e.g., 60 km/h). The ALKS may control the travel on a highway in forward, rearward, left, and right directions. When the vehicle leaves (e.g., drifts away from) a lane in which the vehicle is traveling, the automated lane keeping system may not only output a warning sound but also control a steering wheel to keep within the traveling lane.

While an automated lane keeping function is activated, the vehicle attempts to maintain the traveling lane. However, autonomous driving laws in certain jurisdictions allows an automated driving system to temporarily depart from the traveling lane to create a passageway for an emergency or law enforcement vehicle.

Thus, there is an emerging need for a technology for effectively determining a location of an oncoming emergency vehicle or a law enforcement vehicle.

### SUMMARY

The present disclosure has been made to solve the above-mentioned problems occurring in the prior art while advantages achieved by the prior art are maintained intact.

An aspect of the present disclosure provides a device and a method for controlling a vehicle that enable an automated lane keeping function to operate efficiently by quickly determining a location of an emergency vehicle using sound output from the emergency vehicle.

Another aspect of the present disclosure provides a device and a method for controlling a vehicle that distinguish a relationship between an emergency vehicle route and a host vehicle route based on a location of the emergency vehicle determined using sound output from the emergency vehicle.

Another aspect of the present disclosure provides a device and a method for controlling a vehicle that filter unnecessary information when forming a passage of an emergency vehicle based on a route of a host vehicle and a route of the emergency vehicle.

Another aspect of the present disclosure provides a device and a method for controlling a vehicle that determine a route of an emergency vehicle using sound output from the emergency vehicle and preemptively allow line deviation to facilitate formation of a passage of the emergency vehicle.

The technical problems to be solved by the present disclosure are not limited to the aforementioned problems, and any other technical problems not mentioned herein will be clearly understood from the following description by those skilled in the art to which the present disclosure pertains.

According to one or more example embodiments of the present disclosure, a device for controlling a host vehicle may include: a sensor for obtaining sound associated with a target vehicle; and a controller. The controller may be configured to: determine, based on the sound associated with the target vehicle, an estimated path of the target vehicle; determine, based on a map of an area associated with the host vehicle, road information associated with the estimated path of the target vehicle; determine, based on the road information, whether the target vehicle is anticipated to merge onto a route of the host vehicle; and based on a determination that the target vehicle is anticipated to merge onto the route of the host vehicle, cause the host vehicle to take an evasive action.

The controller may be configured to determine the estimated path based on the host vehicle being in an ignition on state or a power on state.

The controller may be further configured to determine that a second target vehicle is not anticipated to merge onto the route of the host vehicle based on a determination that a direction of an estimated path of the second target vehicle and a moving direction of the host vehicle are different from each other, that the estimated path of the second target vehicle is approaching the host vehicle, and that the estimated path of the second target vehicle is, according to the map, located on an overpass.

The controller may be further configured to determine that a second target vehicle is not anticipated to merge onto the route of the host vehicle based on a determination that a direction of an estimated path of the second target vehicle and a moving direction of the host vehicle are different from each other, that the estimated path of the second target vehicle is approaching the host vehicle, and that a road corresponding to the estimated path of the second target vehicle, according to the map, lacks an adjoining section.

The controller may be further configured to determine that the target vehicle is anticipated to merge onto the route of the host vehicle based on a determination that a direction of the estimated path of the target vehicle and a moving direction of the host vehicle are different from each other, that the estimated path of the target vehicle approaches the host vehicle, based on that a road corresponding to the estimated path of the target vehicle comprises an adjoining section, and that a curvature of the estimated path of the target vehicle, according to the map, matches a curvature of the road corresponding to the estimated path of the target vehicle.

The controller may be further configured to output a message based on a determination that a second target vehicle is not anticipated to merge onto the route of the host vehicle.

The controller may be configured to control, based on a determination that the second target vehicle is not anticipated to merge onto the route of the host vehicle, a driving assistance function of the host vehicle to cause the host vehicle to remain within a traveling lane of the host vehicle.

The controller may be configured to output a message based on a determination that the target vehicle is anticipated to merge onto the route of the host vehicle.

The controller may be configured to cause the host vehicle to take the evasive action by causing a driving assistance function of the host vehicle to create a passageway for the target vehicle.

The target vehicle may include an emergency vehicle.

According to one or more example embodiments of the present disclosure, a method for controlling a host vehicle may include: obtaining sound associated with a target vehicle; determining, based on the sound associated with the target vehicle, an estimated path of the target vehicle; determining, based on a map of an area associated with the host vehicle, road information associated with the estimated path of the target vehicle; determining, based on the road information, whether the target vehicle is anticipated to merge onto a route of the host vehicle; and, based on a determination that the target vehicle is anticipated to merge onto the route of the host vehicle, causing the host vehicle to take the evasive action.

Determining the estimated path of the target vehicle may be based on the host vehicle being in an ignition on state or a power on state.

The method may further include determining that the second target vehicle is not anticipated to merge onto the route of the host vehicle based on a determination that a direction of an estimated path of the second target vehicle and a moving direction of the host vehicle are different from each other, that the estimated path of the second target vehicle is approaching the host vehicle, and that the estimated path of the second target vehicle is, according to the map, located on an overpass.

The method may further include determining that a second target vehicle is not anticipated to merge onto the route of the host vehicle based on a determination that a direction of an estimated path of the second target vehicle and a moving direction of the host vehicle are different from each other, that the estimated path of the second target vehicle is approaching the host vehicle, and that the estimated path of the second target vehicle, according to the map, lacks an adjoining section.

The method may further include determining that the target vehicle is anticipated to merge onto the route of the host vehicle based on a determination that a direction of the estimated path of the target vehicle and a moving direction of the host vehicle are different from each other, that the estimated path of the target vehicle approaches the host vehicle, that a road corresponding to the estimated path of the target vehicle comprises an adjoining section, and that a curvature of the estimated path of the target vehicle, according to the map, matches a curvature of the road corresponding to the estimated path of the target vehicle.

The method may further include outputting a message based on a determination that a second target vehicle is not anticipated to merge onto the route of the host vehicle.

The method may further include controlling, based on a determination that a second target vehicle is not anticipated to merge onto the route of the host vehicle, a driving assistance function of the host vehicle to cause the host vehicle to remain within a traveling lane of the host vehicle.

The method may further include outputting a message based on a determination that the target vehicle is anticipated to merge onto the route of the host vehicle.

Causing the host vehicle to take the evasive action may include causing a driving assistance function of the host vehicle to create a passageway for the target vehicle.

The target vehicle may include an emergency vehicle.

### BRIEF DESCRIPTION OF THE DRAWINGS

The above and other objects, features and advantages of the present disclosure will be more apparent from the following detailed description taken in conjunction with the accompanying drawings:

FIG. 1 is a diagram showing a configuration of a vehicle control device;

FIG. 2 is a diagram schematically illustrating an operation of determining a sound route;

FIGS. 3 to 7 are diagrams showing sound routes classified;

FIGS. 8A and 8B show a flowchart illustrating a vehicle control method; and

FIG. 9 illustrates a configuration of a computing system for executing a method.

### DETAILED DESCRIPTION

Hereinafter, some embodiments of the present disclosure will be described in detail with reference to the exemplary drawings. In adding the reference numerals to the components of each drawing, it should be noted that the identical or equivalent component is designated by the identical numeral even when they are displayed on other drawings. Further, in describing the embodiment of the present disclosure, a detailed description of the related known configuration or function will be omitted when it is determined that it interferes with the understanding of the embodiment of the present disclosure.

In describing the components of the embodiment according to the present disclosure, terms such as first, second, A, B, (a), (b), and the like may be used. These terms are merely intended to distinguish the components from other components, and the terms do not limit the nature, order or sequence of the components. Unless otherwise defined, all terms including technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

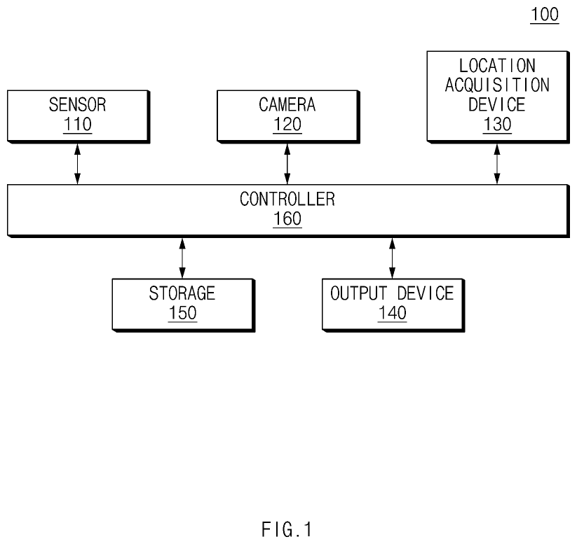

FIG. 1 is a diagram showing a configuration of a vehicle control device.

As shown in FIG. 1, a vehicle control device 100 may include a sensor 110, a camera 120, a location acquisition device 130, an output device 140, storage 150, and a controller 160, and may control travel of a vehicle to which an automated lane keeping system (ALKS) is applied. The vehicle may include a vehicle that is driven by an engine, a motor, or a combination thereof.

The sensor 110 may obtain sound of a target vehicle (e.g., an emergency vehicle). The sensor 110 may include a microphone, and the microphone may be disposed on each of left and right sides of a front portion and left and right sides of a rear portion of the vehicle. In addition, the sensor 110 may sense an object around the vehicle, for example, a preceding vehicle traveling in front of the vehicle, a road, a stationary object including a structure or the like installed near the road, a vehicle approaching in an opposite line, and the like. In addition, the sensor 110 may obtain data including ground information or line information of the road by sensing a line marking of the road or a signal reflected from the ground of the road. For this purpose, the sensor 110 may include a radar or light detection and ranging (Lidar).

The camera 120 may obtain an image of the object around the vehicle, for example, the preceding vehicle traveling in front of the vehicle, the road, the stationary object including the structure or the like installed around the road, the vehicle approaching in the opposite line, and the like. In addition, the camera 120 may obtain a ground image or a line image of the road by capturing the line marking of the road or the ground of the road. For this purpose, the camera 120 may include a front camera, left and right cameras, and a rear camera.

The location acquisition device 130 may have a GPS receiving device to obtain location information of the vehicle, provide a map image of a certain area based on a location of the vehicle by map-matching the location of the vehicle to map data stored in advance, and provide a route from a current location to a destination set by a driver. The location acquisition device 130 may match the location of the vehicle based on an advanced driver-assistance system (ADAS)-based high definition map that enables safe operation of an advanced driver-assistance system (ADAS) including the automated lane keeping system (ALKS). The location acquisition device 130 may provide a movement history of the vehicle and the route to the destination based on the ADAS-based high definition map of the vehicle.

The output device 140 may output a determination result of the controller 160. If the controller 160 determines that the target vehicle (e.g., an emergency vehicle) does not join (e.g., merge onto) a route of a host vehicle, the output device 140 may output the fact that the target vehicle does not join the route of the host vehicle as at least one of an image, sound, or any combination thereof. If the controller 160 determines that the target vehicle joins the route of the host vehicle, the output device 140 may output the fact that the target vehicle joins the route of the host vehicle as at least one of an image, sound, or any combination thereof. In addition, if the controller 160 determines that the target vehicle does not join the route of the host vehicle, the output device 140 may output control information for the host vehicle to travel while maintaining a traveling lane while traveling by activating an automatic driving assistance function. In addition, if it is determined that the target vehicle joins the route of the host vehicle, the output device 140 may output control information for the host vehicle to travel such that a passage for the target vehicle to move is formed while traveling by activating the automatic driving assistance function. To this end, the output device 140 may be implemented as at least one of a display device, a speaker, or any combination thereof.

The storage 150 may store at least one algorithm for calculating or executing various commands for an operation of the vehicle control device. The storage 150 may include at least one storage medium of a flash memory, a hard disk, a memory card, a read-only memory (ROM), a random access memory (RAM), an electrically erasable programmable read-only memory (EEPROM), a programmable read-only memory (PROM), a magnetic memory, a magnetic disk, and an optical disk.

The storage 150 may store the ADAS-based high definition map that enables the safe operation of the advanced driver assistance system. The ADAS-based high definition map may contain the location information of the vehicle, a segment, a stub, a profile short, a profile long, and meta data, and obtain link segment information (a tunnel, a bridge, an overpass, and the like) of the road on which the vehicle is traveling, start information of a new route (adjoining section (e.g., intersection) information: an entry section (a section joined and connected to a main road), a ramp section (a section for connecting roads of different heights and directions to each other), and the like), route properties (a straight line, a ramp, a curvature, a gradient, and the like), and the like.

The controller 160 may be implemented by various processing devices such as a microprocessor or the like including a built-in semiconductor chip or the like capable of calculating or executing various commands, and may control the operation of the vehicle control device. The controller 160 may be electrically connected to the sensor 110, the camera 120, the location acquisition device 130, the output device 140, and the storage 150 via cables or various circuits to transmit an electrical signal including a control command, and the electrical signal including the control command and the like may be transmitted and received via a communication network including controller area network (CAN) communication.

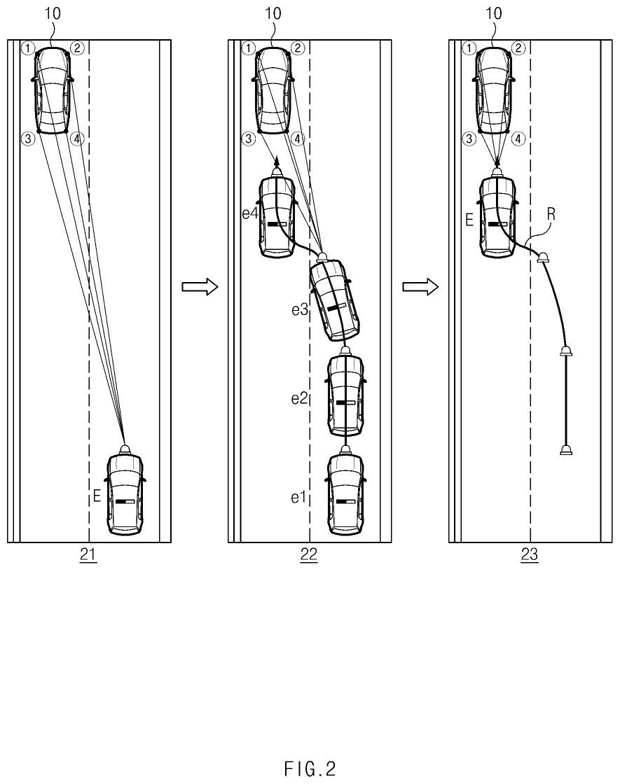

The controller 160 may obtain the sound of the target vehicle and generate (e.g., determine) a sound route based on the sound. The sound route may be a projected (e.g., estimated) route, trace, trajectory, or path of a traveling object that emits sound. In other words, the sound route may be an anticipated path of the origin point (e.g., source) of sound emission. The target vehicle may include a vehicle traveling based on regulations set forth in the statute for emergency business set forth in the statute, may be equipped with a device that generates a siren sound of 90 decibels (dB) or higher and 120 decibels (dB) or lower at a location 30 m in front of the vehicle, and have a warning light including yellow, red, and green flashing lights. For example, a target vehicle such as an emergency vehicle may be equipped with a siren that generates a specific frequency depending on a type thereof. As an example, an ambulance may generate a siren sound having a frequency in a range from 610 to 690 Hz, and a fire engine and a police vehicle may generate a siren sound having a frequency in a range from 300 to 750 Hz. The emergency vehicle may include the ambulance, the fire engine, the police vehicle, a blood delivery vehicle, a vehicle specified in a Presidential Decree (e.g., a motorcade), and the like. The emergency vehicle may travel while turning on the warning light or generating the siren sound when performing the emergency business set forth in the statute, and a general vehicle must give way such that the emergency vehicle may pass first when the emergency vehicle is traveling for the emergency business set forth in the statue. For a more detailed description, see FIG. 2.

FIG. 2 is a diagram schematically illustrating an operation of determining a sound route.

As shown in “21” in FIG. 2, the controller 160 may obtain an arrival time, a wavelength, and a frequency of sound of a target vehicle (e.g., an emergency vehicle) “E” using a first sensor \textcircled{1}, a second sensor \textcircled{2}, a third sensor \textcircled{3}, and a fourth sensor \textcircled{4} in a state of vehicle ignition on or in a state of vehicle power on.

As shown at “22” in FIG. 2, the controller 160 may obtain the sound based on a predetermined period and determine sound generated points e1, e2, e3, and e4 of the target vehicle “E” using a known technology based on a property in which the arrival time, the wavelength, and the frequency of the sound have different values depending on a location of a sound source (the farther the sound source and the sensor are, the longer the arrival time of the sound, the closer the sound source and the sensor are, the shorter the wavelength, and the closer the sound source and the sensor are, the higher the frequency).

As shown in “23” in FIG. 2, the controller 160 may connect locations of the target vehicle to each other to generate a sound route “R”.

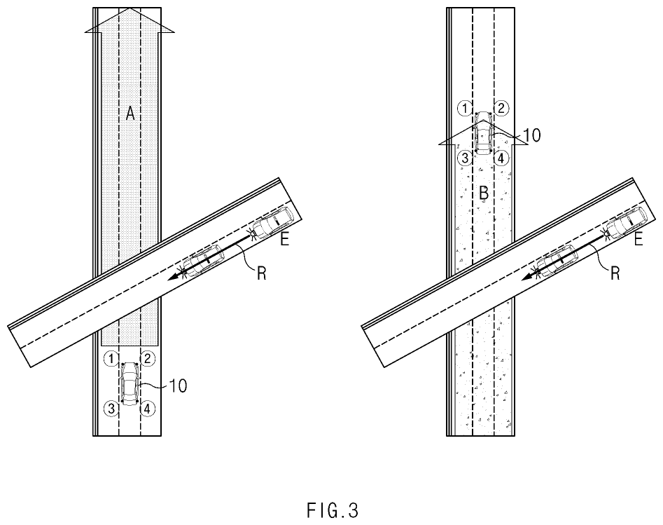

The controller 160 may determine a moving direction of the vehicle based on a map (e.g., a high definition map). The map may be a road map. The moving direction of the vehicle may include a direction to move along a planned route to the destination if the destination has been input, and may include a direction to move along the route along which the vehicle has moved if the destination has not been input. In addition, the controller 160 may generate the sound route based on the sound of the target vehicle, and determine a direction of the sound route and information of a road that matches (e.g., coincides with, maps to, etc.) the sound route based on the high definition map. In addition, the controller 160 may determine a route of the target vehicle based on the information of the road that matches the sound route, and determine whether the target vehicle joins the route of the host vehicle. The route of the host vehicle may include the planned route to the destination and the route along which the vehicle has moved so far. For more specific description, see FIGS. 3 to 7.

FIGS. 3 to 7 are diagrams showing sound routes classified.

As shown in FIG. 3, the controller 160 may determine whether routes A and B of a vehicle 10 match the sound route “R” of the target vehicle (e.g., the emergency vehicle) “E”. The controller 160 may determine whether a direction of the planned route “A” or the route “B” along which the vehicle has moved of the vehicle 10 is the same as the direction of the sound route “R” of the target vehicle “E”.

If the direction of the planned route “A” or the route “B” along which the vehicle has moved of the vehicle 10 is north and the direction of the sound route “R” of the target vehicle “E” is southwest, the controller 160 may determine that the direction of the planned route “A” or the route “B” along which the vehicle has moved of the vehicle 10 is not the same as the direction of the sound route “R” of the target vehicle “E”.

If it has been determined that the direction of the planned route “A” or the route “B” along which the vehicle has moved of the vehicle 10 is not the same as the direction of the sound route “R” of the target vehicle “E”, but it is determined that the sound route “R” of the target vehicle “E” is approaching the road on which the vehicle is traveling and that the segment of the road link of the road that matches the sound route “R” of the target vehicle “E” is determined to be the bridge based on the high definition map, the controller 160 may determine that the target vehicle “E” does not join (e.g., merge onto) the route (the planned route “A” or the route “B” along which the vehicle has moved) of the vehicle.

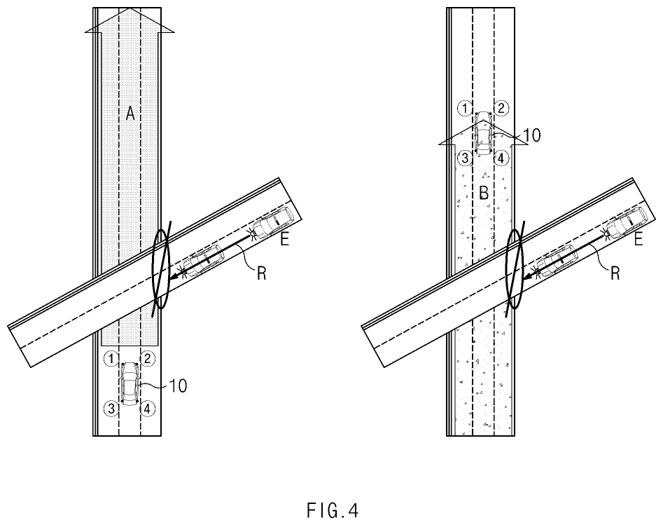

As shown in FIG. 4, the controller 160 may determine whether the routes A and B of the vehicle 10 match the sound route “R” of the target vehicle “E”. The controller 160 may determine whether the direction of the planned route “A” or the route “B” along which the vehicle has moved of the vehicle 10 is the same as the direction of the sound route “R” of the target vehicle “E”.

If the direction of the planned route “A” or the route “B” along which the vehicle has moved of the vehicle 10 is north and the direction of the sound route “R” of the target vehicle “E” is southwest, the controller 160 may determine that the direction of the planned route “A” or the route “B” along which the vehicle has moved of the vehicle 10 is not the same as the direction of the sound route “R” of the target vehicle “E”.

If it has been determined that the direction of the planned route “A” or the route “B” along which the vehicle has moved of the vehicle 10 is not the same as the direction of the sound route “R” of the target vehicle “E”, but it is determined that the sound route “R” of the target vehicle “E” is approaching the road on which the vehicle is traveling and that the segment of the road link of the road that matches the sound route “R” of the target vehicle “E” is determined not to be the bridge, but to be the overpass based on the high definition map, the controller 160 may determine, based on the high definition map, whether there is the entry section, the ramp section, or the like, which is the adjoining section (e.g., an intersection, an onramp, etc.), on the road that matches the sound route “R” of the target vehicle “E”. If there is no entry section or ramp section on the road that matches the sound route “R” of the target vehicle “E”, the controller 160 may determine that the target vehicle “E” does not join the route (the planned route “A” or the route “B” along which the vehicle has moved) of the vehicle.

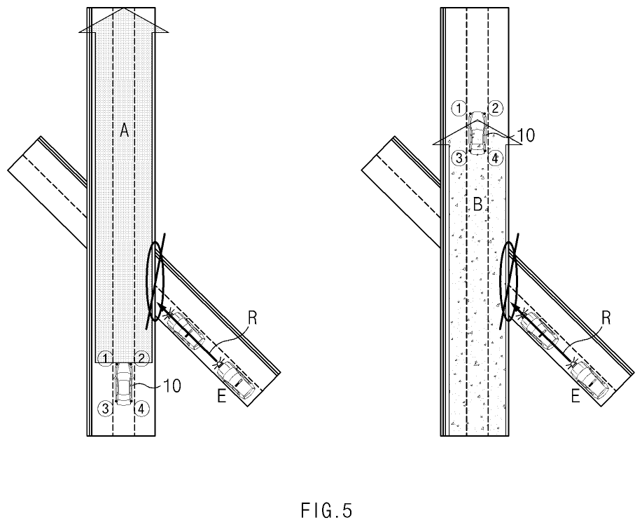

As shown in FIG. 5, the controller 160 may determine whether the routes A and B of the vehicle 10 match the sound route “R” of the target vehicle “E”. The controller 160 may determine whether the direction of the planned route “A” or the route “B” along which the vehicle has moved of the vehicle 10 is the same as the direction of the sound route “R” of the target vehicle “E”.

If the direction of the planned route “A” or the route “B” along which the vehicle has moved of the vehicle 10 is north and the direction of the sound route “R” of the target vehicle “E” is northwest, the controller 160 may determine that the direction of the planned route “A” or the route “B” along which the vehicle has moved of the vehicle 10 is not the same as the direction of the sound route “R” of the target vehicle “E”.

If it has been determined that the direction of the planned route “A” or the route “B” along which the vehicle has moved of the vehicle 10 is not the same as the direction of the sound route “R” of the target vehicle “E”, but it is determined that the sound route “R” of the target vehicle “E” is approaching the road on which the vehicle is traveling and that the segment of the road link of the road that matches the sound route “R” of the target vehicle “E” is determined not to be the bridge, but to be the overpass based on the high definition map, the controller 160 may determine whether there is the entry section, the ramp section, or the like, which is the adjoining section, on the road that matches the sound route “R” of the target vehicle “E” based on the high definition map. If there is no entry section or ramp section on the road that matches the sound route “R” of the target vehicle “E”, the controller 160 may determine that the target vehicle “E” does not join the route (the planned route “A” or the route “B” along which the vehicle has moved) of the vehicle.

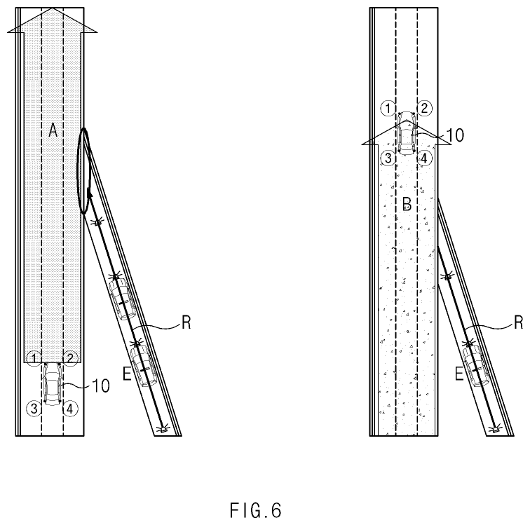

As shown in FIG. 6, the controller 160 may determine whether the routes A and B of the vehicle 10 match the sound route “R” of the target vehicle “E”. The controller 160 may determine whether the direction of the planned route “A” or the route “B” along which the vehicle has moved of the vehicle 10 is the same as the direction of the sound route “R” of the target vehicle “E”.

If the direction of the planned route “A” or the route “B” along which the vehicle has moved of the vehicle 10 is north and the direction of the sound route “R” of the target vehicle “E” is northwest, the controller 160 may determine that the direction of the planned route “A” or the route “B” along which the vehicle has moved of the vehicle 10 is not the same as the direction of the sound route “R” of the target vehicle “E”.

If it has been determined that the direction of the planned route “A” or the route “B” along which the vehicle has moved of the vehicle 10 is not the same as the direction of the sound route “R” of the target vehicle “E”, but it is determined that the sound route “R” of the target vehicle “E” is approaching the road on which the vehicle is traveling and that the segment of the road link of the road that matches the sound route “R” of the target vehicle “E” is determined not to be the bridge based on the high definition map, the controller 160 may determine whether there is the entry section, the ramp section, or the like, which is the adjoining section, on the road that matches the sound route “R” of the target vehicle “E” based on the high definition map. If there is the entry section on the road that matches the sound route “R” of the target vehicle “E”, the controller 160 may determine, based on the high definition map, at least one (the short profile) of curvature information, gradient information, or any combination thereof of the road that matches the sound route “R”.

The controller 160 may determine whether the curvature of the road that matches the sound route “R” is the same as (e.g., substantially matches) a curvature of the sound route “R” based on the high definition map. If it is determined that the curvature of the road that matches the sound route “R” is the same as (e.g., substantially matches) the curvature of the sound route “R”, the controller 160 may determine that the target vehicle “E” joins the route (the planned route “A” or the route “B” along which the vehicle has moved) of the vehicle.

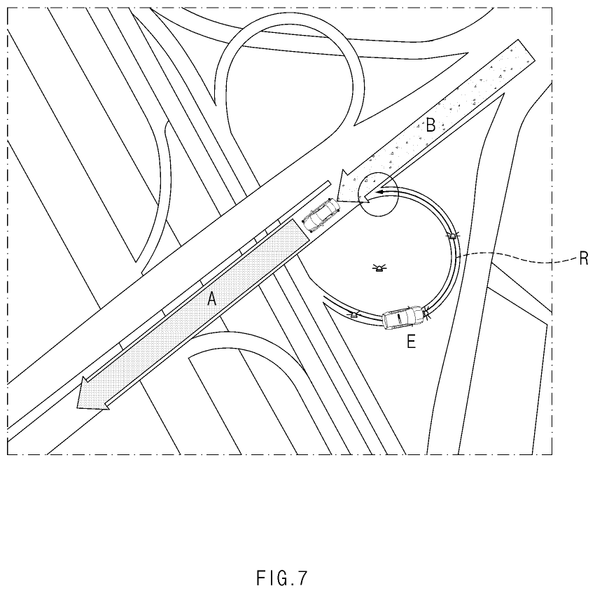

As shown in FIG. 7, the controller 160 may determine whether the routes A and B of the vehicle 10 match the sound route “R” of the target vehicle “E”. The controller 160 may determine whether the direction of the planned route “A” or the route “B” along which the vehicle has moved of the vehicle 10 is the same as the direction of the sound route “R” of the target vehicle “E”.

If the direction of the planned route “A” or the route “B” along which the vehicle has moved of the vehicle 10 is southwest and the direction of the sound route “R” of the target vehicle “E” is a counterclockwise direction, the controller 160 may determine that the direction of the planned route “A” or the route “B” along which the vehicle has moved of the vehicle 10 is not the same as the direction of the sound route “R” of the target vehicle “E”.

If it has been determined that the direction of the planned route “A” or the route “B” along which the vehicle has moved of the vehicle 10 is not the same as the direction of the sound route “R” of the target vehicle “E”, but it is determined that the sound route “R” of the target vehicle “E” is approaching the road on which the vehicle is traveling and that the segment of the road link of the road that matches the sound route “R” of the target vehicle “E” is determined not to be the bridge based on the high definition map, the controller 160 may determine whether there is the entry section, the ramp section, or the like, which is the adjoining section, on the road that matches the sound route “R” of the target vehicle “E” based on the high definition map. If there is the ramp section on the road that matches the sound route “R” of the target vehicle “E”, the controller 160 may determine, based on the high definition map, at least one (the short profile) of the curvature information, the gradient information, or any combination thereof of the road that matches the sound route “R”.

The controller 160 may determine whether the curvature of the road that matches the sound route “R” is the same as the curvature of the sound route “R” based on the high definition map. If it is determined that the curvature of the road that matches the sound route “R” is the same as the curvature of the sound route “R”, the controller 160 may determine that the target vehicle “E” joins the route (the planned route “A” or the route “B” along which the vehicle has moved) of the vehicle.

If it is determined that the target vehicle does not (e.g., will not likely) join the route of the host vehicle, the controller 160 may output the determination result via the output device 140. If it is determined that the target vehicle does not (e.g., will not likely) join the route of the host vehicle, the controller 160 may determine that, because the passage for the target vehicle to move and the route of the host vehicle are not connected to each other, the travel of the host vehicle is irrelevant to the formation of the passage (e.g., emergency passage) of the target vehicle. Accordingly, if the host vehicle travels with the driving assistance function activated, the controller 160 may filter information of the sound route of the target vehicle, so that the information of the sound route of the target vehicle is not considered in activating the driving assistance function. The controller 160 may activate the driving assistance function to control the vehicle to travel while maintaining the traveling lane and output controlled travel information via the output device 140.

Herein, the driving assistance function may include a function that is activated if there is the driver in the vehicle to which the automated lane keeping system (ALKS) is applied and the vehicle travels at a speed lower than a predetermined speed (e.g., 60 km/h) to autonomously control the travel in forward, rearward, left and right directions so as to maintain the lane or change the lane.

On the other hand, if it is determined that the target vehicle joins the route of the host vehicle, the controller 160 may output the determination result via the output device 140. If it is determined that the target vehicle joins the route of the host vehicle, the controller 160 may determine that, because the passage for the target vehicle to move and the route of the host vehicle are connected to each other, the travel of the host vehicle affects the formation of the passage of the target vehicle. Accordingly, if the host vehicle travels with the driving assistance function activated, the controller 160 may not filter the information of the sound route of the target vehicle, so that the information of the sound route of the target vehicle is considered in activating the driving assistance function. The controller 160 may activate the driving assistance function to control the vehicle to travel such that the passage for the target vehicle to move is formed during the travel. If the target vehicle is traveling on the traveling lane of the host vehicle, the controller 160 may control the host vehicle to travel by deflecting to one side of the traveling lane of the host vehicle or control the host vehicle to leave the traveling lane and change the lane to another lane. In addition, the controller 160 may output the controlled travel information via the output device 140.

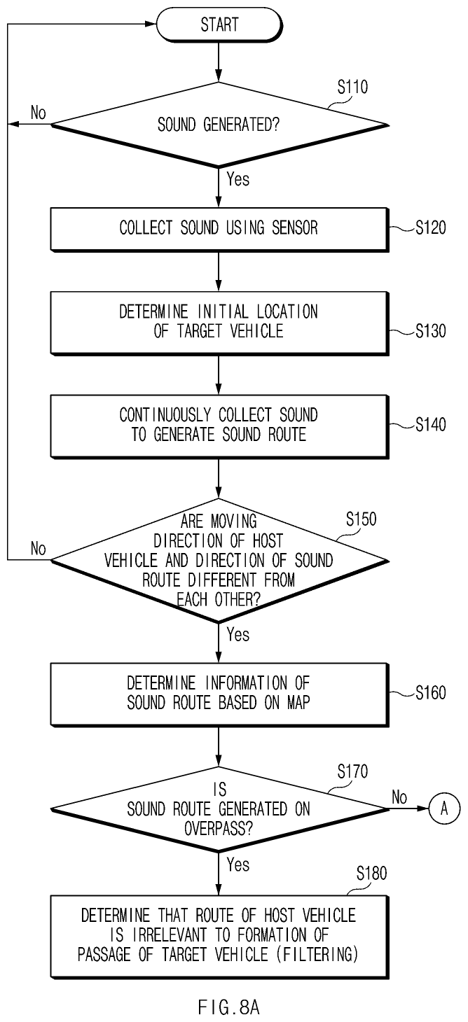

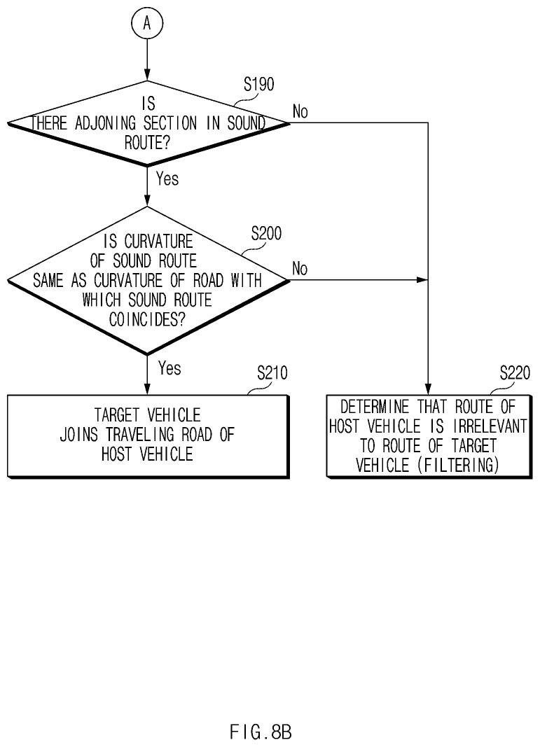

FIGS. 8A and 8B show a flowchart illustrating a vehicle control method.

As shown in FIGS. 8A and 8B, the controller 160 may determine whether the sound of the target vehicle is generated in a state of vehicle ignition on or in a state of vehicle power on (S110).

The controller 160 may collect the sound if it is determined that the sound of the target vehicle is generated (e.g., emitted) (S120). The controller 160 may obtain the sound of a target vehicle (e.g., an emergency vehicle) via the sensor 110. The sensor 110 may include one or more microphones, and the microphone (s) may be disposed on each of the left and right sides of the front portion of the host vehicle, and the left and right sides of the rear portion of the host vehicle.

The controller 160 may determine an initial location of the target vehicle based on the arrival time, the wavelength, and the frequency of the sound of the target vehicle via the sensor 110 (S130).

The controller 160 may obtain the plurality of origin points for the sounds being generated by the target vehicle. By continuously collecting the sounds during a predetermined period of time, the controller 160 may determine a sound route by connecting and/or tracing the plurality of origin points of the sounds collected (S140).

The controller 160 may determine whether the moving direction of the host vehicle and the direction of the sound route are different from each other (S150).

In S150, the controller 160 may determine the moving direction of the host vehicle based on a map (e.g., a high definition map), such as a road map. The moving direction of the host vehicle may include the direction to move along the planned route to the destination if the destination has been input, and may include the direction to move along the route along which the host vehicle has moved if the destination has not been input. In addition, the controller 160 may determine the direction of the sound route based on the map.

If it is determined in S150 that the moving direction of the host vehicle and the direction of the sound route are different from each other, the controller 160 may determine the information of the sound route based on the high definition map (S160). If it is determined in S160 that the sound route is approaching the road on which the host vehicle is traveling, the controller 160 may determine, based on the map, whether the segment of the road link (e.g., intersection) of the road that matches the sound route of the target vehicle is a bridge (S170).

If it is determined in S170 that the segment of the road link of the road that matches the sound route of the target vehicle is a bridge, the controller 160 may determine that the target vehicle does not join (e.g., not anticipated to merge onto) the route of the host vehicle, and output the determination result via the output device 140.

If it is determined that the target vehicle does not join the route of the host vehicle, the controller 160 may determine that, because the passage for the target vehicle to move and the route of the host vehicle are not connected to each other, the travel of the host vehicle is irrelevant to the formation of the passage of the target vehicle (S180).

Accordingly, if the host vehicle travels with the driving assistance function activated, the controller 160 may filter information of the sound route of the target vehicle, so that the information of the sound route of the target vehicle is not considered in activating the driving assistance function. The controller 160 may activate the driving assistance function to control the host vehicle to travel while maintaining the traveling lane and output the controlled travel information via the output device 140.

On the other hand, if it is determined in S170 that the segment of the road link of the road that matches the sound route is not the bridge, the controller 160 may determine whether the start information of the new route exists in the information of the road that matches the sound route based on the high definition map (S190). Herein, the start information of the new route may include the entry section (the section joined and connected to the main road), the ramp section (the section for connecting the roads of the different heights and directions to each other), and the like that are the adjoining sections.

That is, in S190, the controller 160 may determine whether the entry section, the ramp section, or the like exists on the road that matches the sound route.

If it is determined in S190 that there is the entry section, the ramp section, or the like on the road that matches the sound route “R” of the target vehicle (e.g., an emergency vehicle) “E”, the controller 160 may determine at least one (the short profile) of the curvature information, the gradient information, or any combination thereof of the road that matches the sound route “R” based on the high definition map and determine whether the curvature of the road that matches the sound route “R” is the same as the curvature of the sound route “R” (S200).

If it is determined in S200 that the curvature of the road that matches the sound route “R” is the same as the curvature of the sound route “R”, the controller 160 may determine that the target vehicle “E” joins the route (the planned route “A” or the route “B” along which the vehicle has moved) of the vehicle (S210).

If it is determined that the target vehicle joins (e.g., is anticipated to merge onto) the route of the host vehicle, the controller 160 may output the determination result to the output device 140. If it is determined that the target vehicle joins the route of the host vehicle, the controller 160 may determine that, because the passage for the target vehicle to move and the route of the host vehicle are connected to each other, the travel of the host vehicle is affected by the formation (e.g., creation) of the passage (e.g., emergency passage) of the target vehicle. Accordingly, if the host vehicle travels with the driving assistance function activated, the controller 160 may not filter out the information of the sound route of the target vehicle, so that the information of the sound route of the target vehicle is considered in activating the driving assistance function. The controller 160 may activate the driving assistance function to control the vehicle to take evasive action to provide free and safe passage for the target vehicle (e.g., emergency vehicle). For example, the evasive action may include pulling over to a side of the road for safety, or drawing to a side of a traveling lane to create a passageway for the target vehicle. If the target vehicle is traveling on the traveling lane of the host vehicle, the controller 160 may control the host vehicle to travel by deflecting to the one side of the traveling lane of the host vehicle or control the host vehicle to leave the traveling lane and change the lane to another lane. In addition, the controller 160 may output the controlled travel information via the output device 140.

On the other hand, if it is determined in S190 that there is no entry section, the ramp section, or the like on the road that matches the sound route or if it is determined in S200 that the curvature of the road that matches the sound route “R” is not the same as the curvature of the sound route “R”, the controller 160 may determine that the target vehicle does not join the route of the host vehicle and output the determination result via the output device 140.

If it is determined that the target vehicle does not join the route of the host vehicle, the controller 160 may determine that, because the passage for the target vehicle to move and the route of the host vehicle are not connected to each other, the travel of the host vehicle is irrelevant to the formation of the passage of the target vehicle (S220).

Accordingly, if the host vehicle travels with the driving assistance function activated, the controller 160 may filter the information of the sound route of the target vehicle, so that the information of the sound route of the target vehicle is not considered in activating the driving assistance function. The controller 160 may activate the driving assistance function to control the vehicle to travel while maintaining the traveling lane and output the controlled travel information via the output device 140.

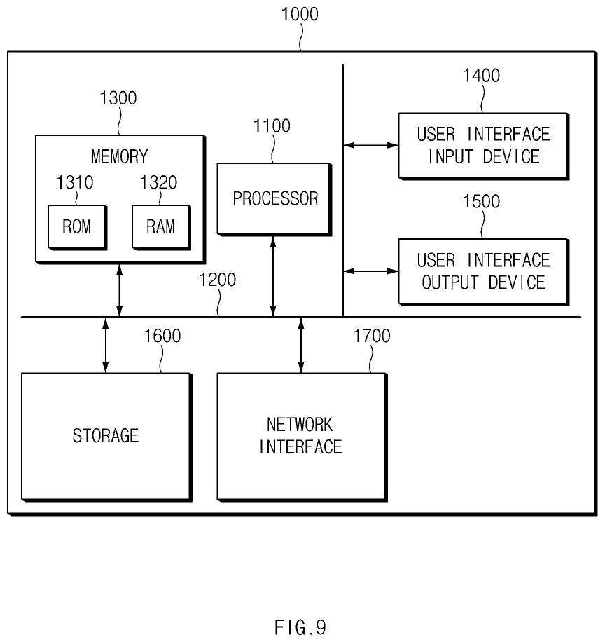

FIG. 9 illustrates a configuration of a computing system for executing a method.

With reference to FIG. 9, a computing system 1000 may include at least one processor 1100, a memory 1300, a user interface input device 1400, a user interface output device 1500, storage 1600, and a network interface 1700 connected via a bus 1200.

The processor 1100 may be a central processing unit (CPU) or a semiconductor device that performs processing on commands stored in the memory 1300 and/or the storage 1600. The memory 1300 and the storage 1600 may include various types of volatile or non-volatile storage media. For example, the memory 1300 may include a ROM (Read Only Memory) 1310 and a RAM (Random Access Memory) 1320.

Thus, the operations of the method or the algorithm described in connection with the embodiments disclosed herein may be embodied directly in hardware or a software module executed by the processor 1100, or in a combination thereof. The software module may reside on a storage medium (that is, the memory 1300 and/or the storage 1600) such as a RAM, a flash memory, a ROM, an EPROM, an EEPROM, a register, a hard disk, a removable disk, and a CD-ROM. The exemplary storage medium is coupled to the processor 1100, which may read information from, and write information to, the storage medium. In another method, the storage medium may be integral with the processor 1100. The processor and the storage medium may reside within an application specific integrated circuit (ASIC). The ASIC may reside within the user terminal. In another method, the processor and the storage medium may reside as individual components in the user terminal.

The description above is merely illustrative of the technical idea of the present disclosure, and various modifications and changes may be made by those skilled in the art without departing from the essential characteristics of the present disclosure.

Therefore, the embodiments disclosed in the present disclosure are not intended to limit the technical idea of the present disclosure but to illustrate the present disclosure, and the scope of the technical idea of the present disclosure is not limited by the embodiments. The scope of the present disclosure should be construed as being covered by the scope of the appended claims, and all technical ideas falling within the scope of the claims should be construed as being included in the scope of the present disclosure.

The device and the method for controlling the vehicle according to one or more embodiments of the present disclosure may enable the automated lane keeping function to operate efficiently by quickly determining the location of the target vehicle using the sound output from the target vehicle.

The device and the method for controlling the vehicle according to one or more embodiments of the present disclosure may distinguish the relationship between the target vehicle route and the host vehicle route based on the location of the target vehicle determined using the sound output from the target vehicle.

The device and the method for controlling the vehicle according to one or more embodiments of the present disclosure may filter out the unnecessary information when creating a passage for emergency vehicles based on the route of the host vehicle and the route of the emergency vehicle.

The device and the method for controlling the vehicle according to one or more embodiments of the present disclosure may determine the route of the target vehicle using the sound output from the target vehicle and preemptively allow the line deviation to facilitate the formation of the passage of the target vehicle.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A device for controlling a host vehicle, the device comprising:
a sensor for obtaining sound associated with a target vehicle; and
a controller configured to:
determine, based on the sound associated with the target vehicle, an estimated path of the target vehicle;
determine, based on a map of an area associated with the host vehicle, road information associated with the estimated path of the target vehicle;
determine, based on the road information, whether the target vehicle is anticipated to merge onto a route of the host vehicle; and
based on a determination that the target vehicle is anticipated to merge onto the route of the host vehicle, cause the host vehicle to take an evasive action.

2. The device of claim 1, wherein the controller is configured to determine the estimated path based on the host vehicle being in an ignition on state or a power on state.

3. The device of claim 1, wherein the controller is further configured to determine that a second target vehicle is not anticipated to merge onto the route of the host vehicle based on a determination that:
a direction of an estimated path of the second target vehicle and a moving direction of the host vehicle are different from each other,
the estimated path of the second target vehicle is approaching the host vehicle, and
the estimated path of the second target vehicle is, according to the map, located on an overpass.

4. The device of claim 1, wherein the controller is further configured to determine that a second target vehicle is not anticipated to merge onto the route of the host vehicle based on a determination that:
a direction of an estimated path of the second target vehicle and a moving direction of the host vehicle are different from each other,
the estimated path of the second target vehicle is approaching the host vehicle, and
a road corresponding to the estimated path of the second target vehicle, according to the map, lacks an adjoining section.

5. The device of claim 1, wherein the controller is further configured to determine that the target vehicle is anticipated to merge onto the route of the host vehicle based on a determination that:
a direction of the estimated path of the target vehicle and a moving direction of the host vehicle are different from each other,
the estimated path of the target vehicle approaches the host vehicle,
a road corresponding to the estimated path of the target vehicle comprises an adjoining section, and
a curvature of the estimated path of the target vehicle, according to the map, matches a curvature of the road corresponding to the estimated path of the target vehicle.

6. The device of claim 1, wherein the controller is further configured to output a message based on a determination that a second target vehicle is not anticipated to merge onto the route of the host vehicle.

7. The device of claim 6, wherein the controller is configured to control, based on a determination that the second target vehicle is not anticipated to merge onto the route of the host vehicle, a driving assistance function of the host vehicle to cause the host vehicle to remain within a traveling lane of the host vehicle.

8. The device of claim 1, wherein the controller is configured to output a message based on a determination that the target vehicle is anticipated to merge onto the route of the host vehicle.

9. The device of claim 8, wherein the controller is configured to cause the host vehicle to take the evasive action by causing a driving assistance function of the host vehicle to create a passageway for the target vehicle.

10. The device of claim 1, wherein the target vehicle comprises an emergency vehicle.

11. A method for controlling a host vehicle, the method comprising:
obtaining sound associated with a target vehicle;
determining, based on the sound associated with the target vehicle, an estimated path of the target vehicle;
determining, based on a map of an area associated with the host vehicle, road information associated with the estimated path of the target vehicle;
determining, based on the road information, whether the target vehicle is anticipated to merge onto a route of the host vehicle; and
based on a determination that the target vehicle is anticipated to merge onto the route of the host vehicle, causing the host vehicle to take the evasive action.

12. The method of claim 11, wherein determining the estimated path of the target vehicle is based on the host vehicle being in an ignition on state or a power on state.

13. The method of claim 11, further comprising determining that the second target vehicle is not anticipated to merge onto the route of the host vehicle based on a determination that:
a direction of an estimated path of the second target vehicle and a moving direction of the host vehicle are different from each other,
the estimated path of the second target vehicle is approaching the host vehicle, and
the estimated path of the second target vehicle is, according to the map, located on an overpass.

14. The method of claim 11, further comprising determining that a second target vehicle is not anticipated to merge onto the route of the host vehicle based on a determination that:
a direction of an estimated path of the second target vehicle and a moving direction of the host vehicle are different from each other,
the estimated path of the second target vehicle is approaching the host vehicle, and
the estimated path of the second target vehicle, according to the map, lacks an adjoining section.

15. The method of claim 11, further comprising determining that the target vehicle is anticipated to merge onto the route of the host vehicle based on a determination that:
a direction of the estimated path of the target vehicle and a moving direction of the host vehicle are different from each other,
the estimated path of the target vehicle approaches the host vehicle,
a road corresponding to the estimated path of the target vehicle comprises an adjoining section, and
a curvature of the estimated path of the target vehicle, according to the map, matches a curvature of the road corresponding to the estimated path of the target vehicle.

16. The method of claim 11, further comprising:
outputting a message based on a determination that a second target vehicle is not anticipated to merge onto the route of the host vehicle.

17. The method of claim 16, further comprising:
controlling, based on a determination that a second target vehicle is not anticipated to merge onto the route of the host vehicle, a driving assistance function of the host vehicle to cause the host vehicle to remain within a traveling lane of the host vehicle.

18. The method of claim 11, further comprising:
outputting a message based on a determination that the target vehicle is anticipated to merge onto the route of the host vehicle.

19. The method of claim 18, wherein the causing the host vehicle to take the evasive action comprises:
causing a driving assistance function of the host vehicle to create a passageway for the target vehicle.

20. The method of claim 11, wherein the target vehicle comprises an emergency vehicle.
